(19) United States
(12) Patent Application Publication
(10) Pub. No.: US 2010/0058771 A1
(43) Pub. Date: Mar. 11, 2010

(54) CARBON REMOVAL FROM AN INTEGRATED THERMAL RECOVERY PROCESS

(75) Inventors: Henry Gil, Calgary (CA); Andrew Squires, Calgary (CA)

Correspondence Address: SHERIDAN ROSS PC, 1560 BROADWAY, SUITE 1200, DENVER, CO, 80202, US

(73) Assignee: OSUM OIL SANDS CORP., Calgary (CA)

(21) Appl. No.: 12/498,895

(22) Filed: Jul. 7, 2009

Related U.S. Application Data
(60) Provisional application No. 61/078,690, filed on Jul. 7, 2008.
(60) Provisional application No. 61/115,822, filed on Nov. 18, 2008.

(51) Int. Cl. F02C 6/18; C01B 3/24; B01J 8/00

(52) U.S. Cl. 60/780; 48/198.3; 48/127.9

(57) ABSTRACT

The present invention is directed to the recovery of hydrocarbons wherein a portion of carbon is removed from the product by a combination of reforming and water-gas shift. The resulting carbon dioxide is removed by known techniques to provide a fuel having reduced levels of carbon.

### CROSS REFERENCE TO RELATED APPLICATION

The present application claims the benefits, under 35 U.S.C. §119(e), of U.S. Provisional Application Ser. No. 61/078,690 filed Jul. 7, 2008, entitled “Carbon Removal from an Integrated Thermal Recovery Process” and U.S. Provisional Application Ser. No. 61/115,822 filed Nov. 18, 2008, entitled “Carbon Removal from an Integrated Thermal Recovery Process” to Gil and Squires, both of which are incorporated herein by these references.

### FIELD

The present invention relates generally to a method and means of removing a portion of carbon from natural gas used to provide steam and electrical power for a large hydrocarbon thermal recovery plant.

### BACKGROUND

There are many hydrocarbon producing regions around the world. These regions may produce hydrocarbons by conventional means or, as production from conventional sources declines, by non-conventional means. For example, conventional means include drilling wells and pumping crude oil or natural gas to the surface. Non-conventional means include recovering bitumen and heavy oil by, for example, thermal stimulation or mining. Producers, especially of some of the non-conventional means which generate significant additional fossil carbon dioxide during recovery and upgrading, are becoming more and more regulated as the link between carbon dioxide emissions and global warming becomes understood.

A prime example of such producers are Steam Assisted Gravity Drain (“SAGD”) and Cyclical Steam Stimulation (“CSS”) operators in the Western Canadian Sedimentary Basin which contains immense reserves of unconventional hydrocarbons, principally in the form of bitumen and heavy oil.

In a conventional SAGD operation, for example, bitumen is recovered, and the bitumen is separated from the recovered water. The water is treated so that it can be used to produce steam in boilers. Diluents are added to the bitumen so that it can be transported by pipeline. Steam is produced primarily by using a fossil fuel energy source such as natural gas, coal, a fuel derived from bitumen and the like. These operations require substantial amounts of energy, much of which is wasted. These operations also generate large amounts of carbon dioxide when producing steam and electrical power and this carbon dioxide is usually released into the atmosphere.

Producing regions such as the Western Canadian Sedimentary Basin are increasingly coming under regulatory pressures to reduce emissions of fossil carbon dioxide, wherein each producer is given the choice of reducing its carbon dioxide emissions, trading for carbon credits or paying a carbon tax. For example, a producer may choose to reduce their fossil carbon dioxide emissions by installing on-site carbon capture and sequestration facilities. In the case of many producers of unconventional hydrocarbons, trading for carbon credits or paying a carbon tax is a less costly and, in the short term, a less risky course of action.

There remains, therefore, a need for an economical method and means of managing the reduction of carbon dioxide emissions from such operations.

### SUMMARY

These and other needs are addressed by the present invention. The various embodiments and configurations of the present invention are directed generally to a process of removing a portion of carbon from natural gas used to generate steam and electrical power e power for a for a hydrocarbon thermal recovery plant, such as for example a SAGD or CSS plant.

In a first embodiment, a process comprising the steps: (a) receiving a gas stream comprising primarily methane; (b) removing a first portion of the gas stream from a second portion of the gas stream; (c) converting the first portion of the gas stream to produce a reformed and water-gas shifted gas comprising primarily carbon dioxide and molecular hydrogen; (d) removing, from the reformed and water-gas shifted gas, at least most of the carbon dioxide to form a product gas; and (e) thereafter combining the product gas with the second portion of the gas stream to form a mixed gas, whereby a carbon content of the mixed gas is reduced relative to the received gas stream.

In second embodiment, a system comprising: an input to receive a gas stream comprising primarily methane; a gas separator to remove a first portion of the gas stream from a second portion of the gas stream; a steam methane reformer reactor to convert the first portion of the gas stream to a reformed gas comprising primarily molecular hydrogen and carbon monoxide; a water-gas shift reactor to convert the reformed gas into a reformed and water-gas shifted gas comprising primarily carbon dioxide and molecular hydrogen; a carbon separator to remove, from the reformed and water-gas shifted gas, at least most of the carbon dioxide to form a product gas; and a gas combiner to combine the product gas with the second portion of the gas stream to form a mixed gas, whereby a carbon content of the mixed gas is reduced relative to the received gas stream.

In other embodiments, a method/system is/are provided that perform the following steps/operations: (a) forming, from an input gas stream comprising primarily methane, an intermediate gas stream comprising primarily gas-phase molecular hydrogen and carbon oxide; (b) contacting the intermediate gas stream with an alkali and/or alkaline earth metal oxide to form a second intermediate gas stream comprising molecular hydrogen and carbonates; (c) removing at least most of the molecular hydrogen from the second intermediate gas stream to form a product gas stream comprising primarily molecular hydrogen and a third intermediate gas stream comprising at least most of the carbonates; (d) converting, using heat from the forming step (a), at least most of the carbonates in the third intermediate gas stream to gas-phase carbon oxide and alkali and/or alkaline earth metal oxide; (e) removing at least most of the gas-phase carbon oxide from the alkali and/or alkaline earth metal oxide; and (f) recycling the separated alkali and/or alkaline earth metal oxide to step (b).

In one configuration, the product gas comprises no more than about 25% of the carbon present in the input gas stream.

The various embodiments can have a number of advantages. By way of example, the embodiments can reduce significantly fossil carbon emissions from fossil fuels. The embodiments can convert fossil carbon into carbon dioxide for sequestration. The resulting molecular hydrogen is itself a fuel. The embodiments can significantly reduce, relative to conventional processes, energy waste. By using energy more efficiently, heavy oil deposits may be exploited more inexpensively.

The following definitions are used herein:

Calcination (also referred to as calcining) is a thermal treatment process applied to ores and other solid materials in order to bring about a thermal decomposition, phase transition, or removal of a volatile fraction. The calcination process normally takes place at temperatures below the melting point of the product materials. Calcination takes place in the absence of air. The process of calcination derives its name from its most common application, the decomposition of calcium carbonate (limestone) to calcium oxide (lime). The product of calcination is usually referred to in general as “calcine,” regardless of the actual minerals undergoing thermal treatment

A carbon sequestration facility is a facility in which carbon dioxide can be controlled and sequestered in a repository such as for example a mature or depleted oil and gas reservoir, an unmineable coal seam, a deep saline formation, a basalt formation, a shale formation, or an excavated tunnel or cavern.

Dilbit is short for diluted bitumen. Typically, dilbit is about 65% bitumen diluted with about 35% naphtha. The naphtha is added to make a fluid that can be transported by pipeline by reducing the viscosity of the bitumen/naphtha mixture. The dilbit can be transported by pipeline to a refinery. The naphtha diluent can be taken out as a straight run naphtha/gasoline and reused as diluent. Or it is processed to products in the refinery. The dilbit has a lot of light hydrocarbons from the diluent and a lot of heavy hydrocarbons from the bitumen. So it is a challenge to process directly in a normal refinery. Dilbit can only be a small part of a normal refinery's total crude slate. In addition to naphtha, condensate can also be used as diluent.

A duct burner as used herein is any industrial combustor or burner that is operated at close to ambient pressure.

EOR stands for Enhanced Oil Recovery

HRSG stands for Heat Recovery Steam Generator. A heat recovery steam generator or HRSG is a heat exchange apparatus that recovers heat from a hot gas stream to produce steam. The hot gas stream can be provided, for example, by the hot exhaust from a gas turbine.

A hydrocarbon transport means as used herein includes any means of bulk hydrocarbon transport including but not limited to a pipeline, a train of tank cars or gondolas, a ship, a barge or a truck convoy.

A mobilized hydrocarbon is a hydrocarbon that has been made flowable by some means. For example, some heavy oils and bitumen may be mobilized by heating them or mixing them with a diluent to reduce their viscosities and allow them to flow under the prevailing drive pressure. Most liquid hydrocarbons may be mobilized by increasing the drive pressure on them, for example by water or gas floods, so that they can overcome interfacial and/or surface tensions and begin to flow.

Natural gas refers to a hydrocarbon gas including low molecular weight hydrocarbons, primarily methane. The low molecular weight hydrocarbons commonly include, in addition to methane, ethane, propane, and butane. A typical natural gas-containing product contains from about 50 to about 98 mole percent methane, from about 1 to about 15 mole percent ethane, and up to about 5 mole percent propane and butane. The product may contain various sulfur, nitrogen and carbon dioxide compounds as contaminants.

Pipeline quality natural gas is specified for example by the American Gas Association and Canadian Gas Association. Typically, there are limits on sulphur, carbon dioxide, water and other constituents of natural gas obtained from nature to comply with pipeline specifications.

Primary production or recovery is the first stage of hydrocarbon production, in which natural reservoir energy, such as gas-drive, water-drive or gravity drainage, displaces hydrocarbons from the reservoir, into the wellbore and up to surface. Production using an artificial lift system, such as a rod pump, an electrical submersible pump or a gas-lift installation is considered primary recovery. Secondary production or recovery methods frequently involve an artificial-lift system and/or reservoir injection for pressure maintenance. The purpose of secondary recovery is to maintain reservoir pressure and to displace hydrocarbons toward the wellbore. Tertiary production or recovery is the third stage of hydrocarbon production during which sophisticated techniques that alter the original properties of the oil are used. Enhanced Oil Recovery can begin after a secondary recovery process or at any time during the productive life of an oil reservoir. Its purpose is not only to restore formation pressure, but also to improve oil displacement or fluid flow in the reservoir. The three major types of enhanced oil recovery operations are chemical flooding, miscible displacement and thermal recovery.

A producer is a any producer of natural gas, oil, heavy oil, bitumen, peat or coal from a hydrocarbon reservoir.

Reforming means fossil fuel reforming which is a method of producing useful products, such as hydrogen or ethylene from fossil fuels. Fossil fuel reforming is done through a fossil fuel processor or reformer. At present, the most common fossil fuel processor is a steam reformer. This conversion is possible as hydrocarbons contain much hydrogen. The most commonly used fossil fuels for reforming today are methanol and natural gas, yet it is possible to reform other fuels such as propane, gasoline, autogas, diesel fuel, methanol and ethanol. During the conversion, the leftover carbon dioxide is typically released into the atmosphere. On an industrial scale, reforming is the dominant method for producing hydrogen. The basic chemical reaction for reforming is:

CₙHₘ+nH₂O→nCO+(m/2+n)H₂

This reaction is endothermic. The produced carbon monoxide can combine with more steam to produce further hydrogen via the water gas shift reaction.

Synbit is a blend of bitumen and synthetic crude. Synthetic crude is a crude oil product produced, for example, by the upgrading and refining of bitumen or heavy oil. Typically, synbit is about 50% bitumen diluted with about 50% synthetic crude.

SMR stands for Steam Methane Reformer.

Syngas (from synthesis gas) is the name given to a gas mixture that contains varying amounts of carbon monoxide and hydrogen. Examples of production methods include steam reforming of natural gas or liquid hydrocarbons to produce hydrogen, the gasification of coal and in some types of waste-to-energy gasification facilities. The name comes from their use as intermediates in creating synthetic natural gas and for producing ammonia or methanol. Syngas is also used as an intermediate in producing synthetic petroleum for use as a fuel or lubricant via Fischer-Tropsch synthesis and previously the Mobil methanol to gasoline process. Syngas consists primarily of hydrogen, carbon monoxide, and very often some carbon dioxide, and has less than half the energy density of natural gas. Syngas is combustible and often used as a fuel source or as an intermediate for the production of other chemicals.

Upgrading (including partial upgrading) as used herein means removing carbon atoms from a hydrocarbon fuel, replacing the removed carbon atoms with hydrogen atoms to produce an upgraded fuel and then combining the carbon atoms with oxygen atoms to form carbon dioxide.

The water-gas shift reaction is a chemical reaction in which carbon monoxide reacts with water to form carbon dioxide and hydrogen:

CO+H₂O→CO₂+H₂

The water-gas shift reaction is often used in conjunction with steam reforming of methane or other hydrocarbons. The water-gas shift reaction is slightly exothermic, yielding 42 kJ per mole. The process is often used in two stages, stage one a high temperature shift at 350° C. and stage two, a low temperature shift at 190 to 210° C.

It is to be understood that a reference to diluent herein is intended to include solvents.

It is to be also understood that a reference to oil herein is intended to include low API hydrocarbons such as bitumen (API less than ˜10°) and heavy crude oils (API from ˜10° to ˜20°) as well as higher API hydrocarbons such as medium crude oils (API from ˜20° to ˜35°) and light crude oils (API higher than ˜35°). A reference to bitumen is also taken to mean a reference to low API heavy oils.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

FIG. 1 is a schematic showing the principal elements of a typical prior art SAGD operation using natural gas for power.

FIG. 2 is schematic of the present invention showing the principal elements of an integrated SAGD operation using natural gas for power.

FIG. 3 is a schematic of the present invention showing the principal elements of the innovative portion of an integrated SAGD operation of FIG. 2.

FIG. 4 is a partial schematic of FIG. 3 highlighting fuel and other gas pathways.

FIG. 5 is a partial schematic of Figure highlighting water and steam pathways.

FIG. 6 is a schematic of a pre-combustion CO₂ capture process.

FIG. 7 is schematic of the present invention showing the principal elements of the innovative portion of an integrated SAGD operation with the pre-combustion CO₂ capture process of FIG. 6.

### DETAILED DESCRIPTION

In various embodiments, natural gas is used as the primary energy source but a first portion of the natural gas is reformed to produce carbon dioxide and hydrogen in a carbon extraction plant integrated into a main bitumen process plant. The carbon dioxide is liquified and can be sequestered, used for EOR operations, sold or otherwise controlled such that it is not released into the atmosphere. The hydrogen is mixed with a second portion of the natural gas to produce a high energy fuel for operating other apparatuses in the plant. This removal of a portion of carbon from the emissions requires some additional energy but the plant is configured in such a way as to utilize as much waste heat as possible so that the overall plant processes more bitumen and releases less carbon dioxide for about the same energy consumption as a conventional SAGD operation. As a result the plant operator may be eligible for a carbon credit or at least a reduced carbon tax.

In one configuration carbon dioxide is removed pre-combustion by well known processes such as for example the Selexol process. In another configuration, carbon dioxide is removed pre-combustion by a fluidized bed reactor approach and carbon dioxide is removed from the sorbent by heat generated in the steam methane reformer reactor.

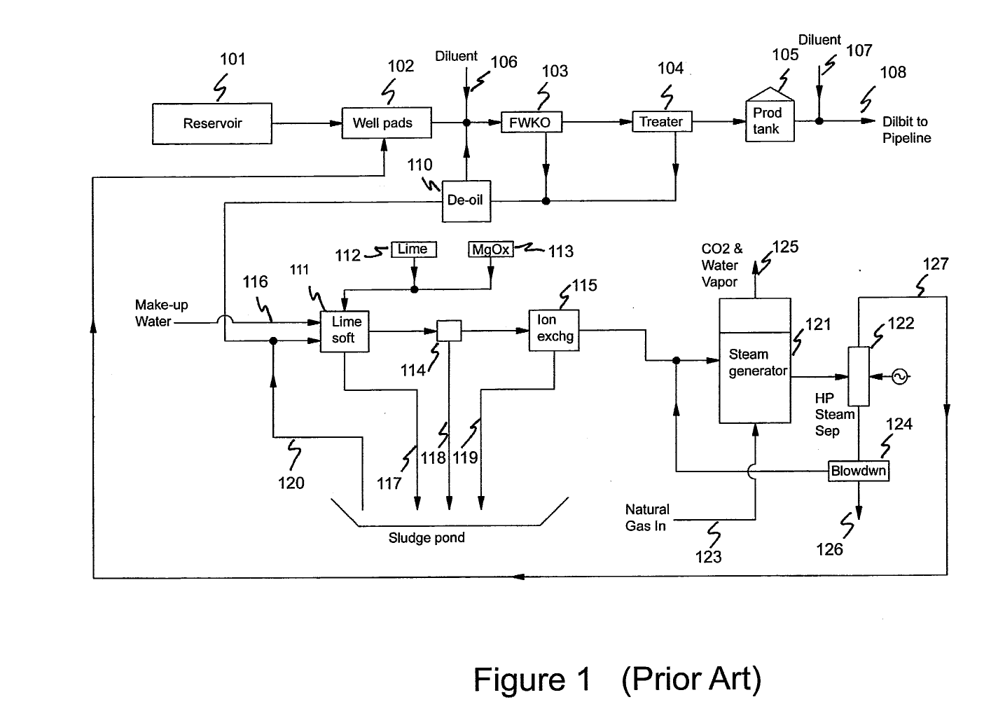

FIG. 1 is a schematic showing the principal elements of a typical prior art SAGD operation using natural gas for power. In this example, 30,000 barrels per day (“bpd”) of bitumen are processed using approximately 34 million standard cubic feet per day of natural gas as fuel. This translates to 1,133 standard cubic feet per day of natural gas burned to process a barrel of bitumen. The eventual product of this plant is a 19° to 20° API dilbit. Often bitumen recovered from a SAGD operation is shipped to a refinery for upgrading. If shipment is made by pipeline, a diluent must be added to the bitumen to allow the blend to flow. In a typical SAGD operation, recovered bitumen is partially upgraded to an approximately 20° API product which can then be transported by pipeline to a refinery.

As shown in FIG. 1, raw bitumen-water feedstock from a well pad facility 102 is fed into a bitumen-water separation sequence comprising a Free Water Knock-Out (“FWKO”) unit 103. Diluent 106 is added to the raw bitumen-water feedstock to form a pumpable mixture prior to entering the FWKO unit 103. The FWKO unit 103 separates most of the diluent-bitumen mixture (“dilbit”). This dilbit mixture is then sent to an oil treatment unit 104 which separates the remaining water from the dilbit. Additional diluent 107 is added to the dilbit product which is then sent to a product storage tank 105, where it remains ready, for example, for transport by pipeline 108 to an upgrader.

The water from the oil treatment unit 104 is sent to a de-oiling unit 110 for final cleaning of remaining oil residue. The oil residue from the de-oiling unit 110 is returned to the feedstock of the FWKO unit 103. Make-up water 116 from a water well source is added to the de-oiled water and then fed to a series of water treatment apparatuses which purify the water in preparation for making steam. The water treatment apparatuses are typically comprised of water softener units 111, walnut filter unit 114 and an ion exchange unit 115. The treated water is fed to steam generators 121 which are used to produce primarily hot dry steam which is sent to a high pressure steam separator unit 122.

Natural gas 123 is used to power the steam generators 121. These steam generators may be large single pass boilers or they may be multi-pass drum steam generators. In the 30,000 bpd example, about 2,700 tons per day of CO₂ is released 125 into the atmosphere by the drum steam generators 121 which is about 0.09 tons CO₂ released per barrel of bitumen processed.

The high pressure steam separator unit 122 compresses the steam from the steam generators 121 and delivers the hot, high-pressure, high-quality steam to the well pads 102 for injection into the bitumen reservoir 101 where it is used to continue the bitumen mobilization and recovery process. Condensate (˜1 to 2% of the steam) from the high pressure steam separator unit 122 is handled by a blowdown apparatus 124 and sent to a water disposal well 126.

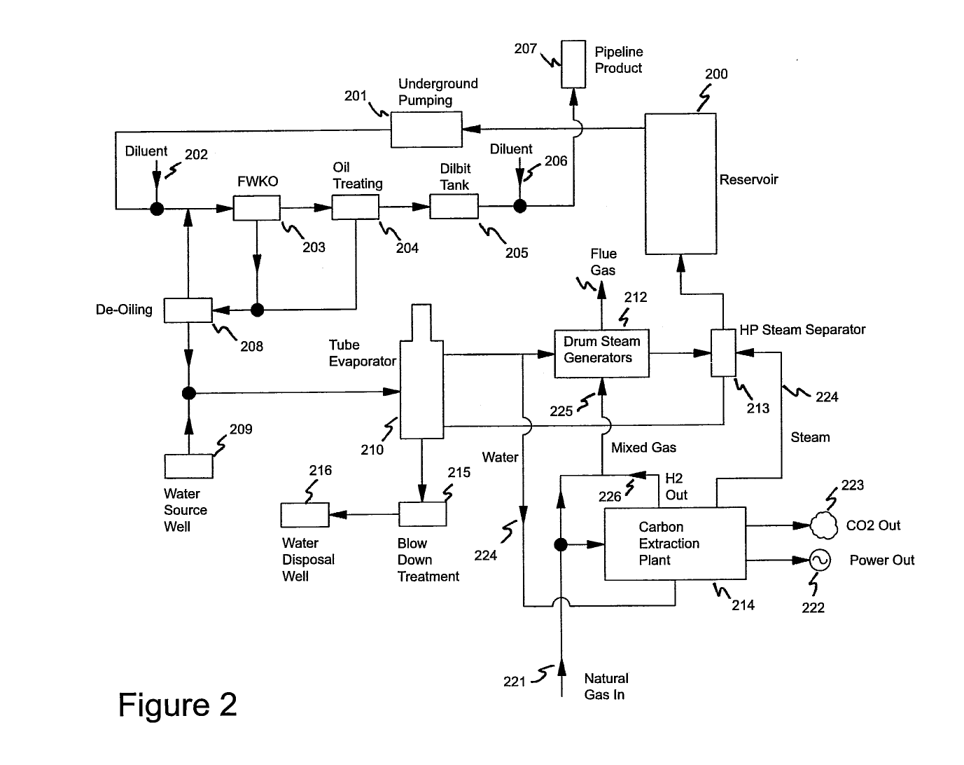

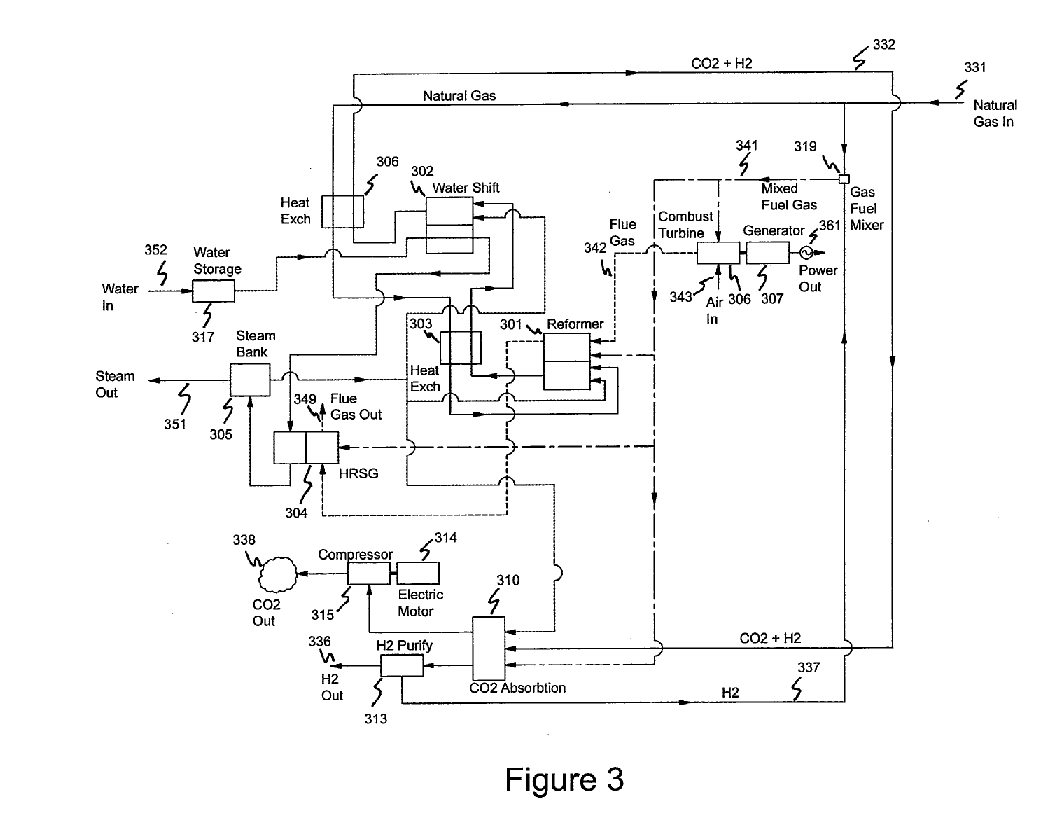

FIG. 2 is schematic of the present invention showing the principal elements of an integrated SAGD operation using natural gas for power. Natural gas fuel 221 is brought into the facility and a substantial fraction of the natural gas is diverted by a gas separator and reformed and water-gas shifted in a carbon extraction plant to eliminate carbon in the form of captured carbon dioxide (“CO₂”). As will be discussed in FIG. 3, this is done while also generating electrical energy and steam. Therefore, an innovation is the addition of a carbon extraction plant that modifies a portion of the natural gas fuel input to the main plant. The carbon extraction plant delivers clean CO₂, molecular hydrogen and electrical power. The molecular hydrogen is then mixed by a gas combiner with portion of natural gas not sent to the carbon extraction plant to form a mixed gas fuel which is then used to power steam generators and other apparatuses in the main plant. In a typical application, at least about 20% of the methane by volume, more typically about 40% of the methane by volume, and as high as about 60% of the methane by volume of the natural gas is converted into molecular hydrogen. Relative to conventional processes in which natural gas is combusted, this use of mixed fuel commonly reduces fossil carbon emissions by at least about 20% and as high as about 60%.

In the example of FIG. 2, 40,000 barrels per day (“bpd”) of bitumen are processed using approximately 42 million standard cubic feet per day of natural gas as fuel 221. This translates to 1,050 standard cubic feet per barrel of bitumen or slightly more efficient than the prior art plant described in FIG. 1. However, only 26 million standard cubic feet per day of natural gas are burned since 16 million standard cubic feet per day of natural gas are reformed and water-gas shifted to remove carbon. Thus, in the present invention, only 650 standard cubic feet of natural gas is burned to process a barrel of bitumen. The remaining energy required to operate the plant is obtained from molecular hydrogen (“H₂”) generated by the reforming and water-gas shift processes. The reforming and water-gas shift processes also generate 31 million standard cubic feet per day of CO₂ which is captured, purified and compressed to 1,000 psi. The bitumen product is a 19° to 20° API dilbit which is the same as that of the prior art plant described in FIG. 1.

The raw feedstock for the process of the present invention is bitumen or heavy oil recovered by a mining or in-situ operation. An example of a mining operation would be a hydraulic mining operation which produces an oil sand slurry. An example of hydraulic mining conducted from an underground workspace is disclosed in U.S. Provisional Patent Application No. 60/867,010 entitled “Recovery of Bitumen by Hydraulic Excavation” to Brock, Squires, Watson and filed Nov. 22, 2006 which is incorporated herein by this reference. The bitumen, water and sand from a hydraulic mining operation can be separated, for example, by hydrocyclone methods. An example of this method of separation is disclosed in U.S. Pat. No. 7,128,375 issued Oct. 31, 2006, entitled “A Method and Means for Recovering Hydrocarbons from Oil Sands by Underground Mining” to Watson also which is incorporated herein by this reference.

An example of an in-situ recovery operation is a Steam Assisted Gravity Drain (“SAGD”) operation which produces a product stream of water, hot bitumen and gas. SAGD operations can be carried out from a surface facility or from an underground workspace. An example of this latter approach is disclosed in U.S. patent application Ser. No. 11/441,929 entitled “Method for Underground Recovery of Hydrocarbons” to Brock, Kobler and Watson, filed May 26, 2006.

The bitumen recovered from a thermal recovery operation such as SAGD or Cyclical Steam Stimulation (“CSS”) contains a large amount of water. A small fraction is connate water but most of the water is produced as condensate from the steam used to heat and mobilize the bitumen. As shown in the example of FIG. 2, a SAGD steam chamber 200 is the reservoir or source of bitumen, condensed water along with dissolved and free gases such as CH₄, CO₂, H₂S and other trace gases. The source material is recovered from the steam chamber 200 by producer wells such as used, for example, in SAGD or CSS, or by non-thermal processes such as VAPEX or by a combination of these processes that can cause the bitumen to be mobilized and recovered. The produced source material is then sent to an underground location 201 for storage and processing or for storage, pumping to the surface and processing. Thus, the process of the present invention may be carried out on the surface, underground or portions of the process may be carried out underground. While the producer well-heads are assumed to be underground for purposes of the present illustration, the well heads may be located on the surface.

One of the products of the process of the present invention is hot, dry, pressurized steam which may be returned to the underground location and finally to the reservoir 200 for ongoing steaming (SAGD or CSS) operations. Other products of the process of the present invention, such as for example, CO₂, NOₓ and SO₂, may also be captured and returned to the underground location and finally to the reservoir 200 or other geologic repository for sequestration.

The raw bitumen-water feedstock from underground storage 201 is fed into a bitumen-water separation sequence comprising a Free Water Knock-Out (“FWKO”) unit 203. Diluent 202 is added to the raw bitumen-water feedstock to form a pumpable mixture prior to entering the FWKO unit 203.

The de-oiled bitumen-diluent mixture from the FWKO unit 203 is fed to an oil treating unit 204 where at least most of the residual water is removed and added to the input of the water de-oiling unit 208. The treated hydrocarbon mixture, typically, dilbit is sent to a product storage tank 205. Additional diluent 206 is added to the dilbit product so that it can be transported by pipeline 207 to an upgrader.

In a typical 40,000 barrel per day (“bpd”) bitumen recovery operation, typically about 55,000 bpd of 19° to 20° API dilbit is produced, the exact amount of dilbit produced being a function of the API grade of the recovered bitumen.

The FWKO unit 203 separates most of the water which is then sent to a de-oiling unit 208 for final cleaning of remaining oil residue. The oil residue from the de-oiling unit 208 is returned to the feedstock of the FWKO unit 203. Make-up water from a water well source 209, for example, is added to the de-oiled water and then fed to a tube evaporator 210 which distills the water in preparation for making steam. Some water is condensed in the tube evaporator 210 and is processed by a blowdown treatment apparatus 215 and then returned to the ground via a water disposal well 216. It is understood that reference to a tube evaporator may mean a rising tube evaporator or a falling tube evaporator since both accomplish the same function in process of the present invention.

In a typical 40,000 barrel per day bitumen recovery operation, from about 80,000 to about 150,000 bpd of water may be recovered. Most of this is condensate when a thermal process such as SAGD is used. Typically there is on the order of about 100 to 125 kg of connate water and on the order of about 200 to 300 kilograms bitumen recovered for every cubic meter of in-situ deposit mobilized. In a typical 40,000 bpd SAGD bitumen recovery operation, an amount of make-up water from the water well source 209 is added to the de-oiled water prior to being fed to the tube evaporator 210. The amount of make-up water is in the range of about 5% to about 15% of the amount of water recovered from the SAGD operation.

The distilled water from the tube evaporator 210 is fed to the steam drum generators 212 which are used to produce primarily hot dry steam which is sent to a high pressure steam separator unit 213. A mixture of molecular hydrogen and methane (called a mixed gas) are used to power the steam drum generators 212 as described below. The primary function of the steam drum generators 212 is to produce high quality steam which is transferred to a high pressure steam separator unit 224.

The high pressure steam separator unit 213 compresses the steam from the steam drum generators 212 and delivers the hot, high-pressure, high-quality steam to the underground facility 200 for subsequent use in maintaining temperature and pressure conditions in steam chamber. Water condensate from the high pressure steam separator unit 213 is returned to the tube evaporator 210.

As discussed above, natural gas fuel 221 is brought into the facility and a substantial fraction of the natural gas is diverted and reformed and water-gas shifted to eliminate carbon in the from of captured carbon dioxide (“CO₂”) in a carbon extraction plant 214. A portion of input natural gas 221 is diverted through the carbon extraction plant 214 and hydrogen 228 is output and mixed with the natural gas that by-passes the carbon extraction plant 214, to form a mixed gas which is typically about 40% molecular hydrogen and about 60% natural gas by volume. The amount of the natural gas fuel diverted through the plant 214 depends on the application and local carbon emission regulations and the mixed gas may vary in composition from about 20% to about 60% molecular hydrogen by volume, corresponding to about 80% to about 40% natural gas by volume.

The overall steam reforming and water-gas shift reaction is:

CH₂+2H₂O→CO₂+4H₂

Thus for each methane molecule input, four molecules of hydrogen and one molecule of carbon dioxide are created. The carbon dioxide is captured and available to be sequestered.

Most of the electrical power for the entire operation is generated in the carbon extraction plant 214. The carbon extraction plant 214 is also referred to as a Power-SMR-Steam unit (SMR stands for Steam Methane Reformer).

The first step of the SMR process involves methane reacting with steam at 850° C. or above to produce a synthesis gas (syngas), a mixture primarily made up of molecular hydrogen (H₂) and carbon monoxide (CO). In the reforming step, typically about 90% to about 95% of the methane is converted to carbon monoxide and molecular hydrogen. In the second step, known as a water gas shift (WGS) reaction, the carbon monoxide produced in the first reaction is reacted with steam over a catalyst to form molecular hydrogen and carbon dioxide (CO₂). This process can be accomplished in a high temperature shift reactor at about 350° C. or in a low temperature shift reactor at about 190° C. to about 210° C. In the water shift step, more than about 90% of the carbon monoxide is typically converted to carbon dioxide.

In this example, 42 MMSCFD of natural gas enters the plant and 16 million standard cubic feet per day (about 38%) is diverted to carbon extraction plant 214. As will be discussed in FIG. 3, the carbon extraction plant 214 outputs over 30 million standard cubic feet per day of CO₂ at 1,000 psi; 24 MW of electrical power; around 200,000 lbs per hour of steam and about 64 million standard cubic feet per day of hydrogen.

The steam is added to the high pressure steam separator 213; the 24 MW of power is used to operate the various units in the carbon extraction plant 214 and the main plant; the CO₂ 223 is sold, used for EOR or sequestered; and the recovered hydrogen 226 is mixed with the 26 million standard cubic feet per day of natural gas 221 to produce a high energy gas mix that is used in the burners of the steam drum generators 212. Thus, the carbon extraction plant 214 removes a substantial portion of fossil carbon while using slightly less energy to process a barrel of bitumen and produce steam than the prior art plant of FIG. 1.

About 2,880 tons per day of CO₂ is released into the atmosphere by the drum steam generators 212 which is about 0.072 tons CO₂ released per barrel of bitumen processed.

In the example of FIG. 2, 40,000 bpd of bitumen is processed using 42 million standard cubic feet of natural gas and releasing 2,880 tons of CO₂ into the atmosphere. In the prior art plant of FIG. 1, 30,000 bpd of bitumen is processed using 34 million standard cubic feet of natural gas and releasing 2,700 tons of CO₂ into the atmosphere. Thus the integrated plant of FIG. 2 releases only about 80% the carbon dioxide per barrel of bitumen processed as does the prior art plant of FIG. 1. By increasing the portion of incoming natural gas diverted to the carbon extraction plant, the integrated plant can release as little as about 70% the carbon dioxide per barrel of bitumen processed as does the prior art plant.

FIG. 3 is a schematic of the present invention showing a carbon extraction plant (item 214 in FIG. 2) which is a principal innovative system of the integrated SAGD operation described in FIG. 2.

Natural gas is the fuel for the carbon extraction plant. The natural gas is pre-heated to a temperature commonly less than 850° C. (the temperature at which the methane molecules break apart) by two heat exchangers then used as fuel for a steam methane reformer reactor and water-gas shift reactor. In the steam methane reformer, at least most of the methane in the input natural gas stream is converted into molecular hydrogen and carbon monoxide. The output of the steam methane reformer 301 ranges from about 25 to about 95 mole percent molecular hydrogen (H₂) and from about 5 to about 75 mole percent carbon monoxide (CO). The water-gas shift process converts typically at least most and more typically about 90% to about 95% of CO to CO₂. The output of these two processes is CO₂ and H₂ which goes to a CO₂ absorption (or carbon separator) apparatus. Typically, at least about 90% and as much as about 95% of the methane is converted into carbon dioxide and molecular hydrogen by the combined processes. A portion of the CO₂ is directed to an electrically powered compressor to create CO₂ for sale, for EOR operations or for delivery to be sequestered. A second portion of the H₂ from the CO₂ absorption apparatus is purified. Some of this H₂ may be removed for sale and some is mixed with a portion of natural gas in gas fuel mixer to make a mixed gas fuel. This mixed gas fuel is used to power a combustion turbine, the steam methane reformer, an HRSG facility and the CO₂ absorption apparatus. Water is brought in and preheated in the water-gas shift reactor to a temperature ranging from about 50° C. to about 300° C. and then sent to the HRSG facility where steam is produced and sent to a steam bank. Some steam is sent back to the steam generators in the main plant. Some steam is sent to the steam methane reformer, some to the water-gas shift reactor and some to the CO₂ absorption apparatus. Flue gases from the combustion turbine are mixed with fuel and used in a duct burner in the steam methane reformer to power the HRSG facility.

In the 40,000 bpd example of FIG. 2, 26 million standard cubic feet per day of natural gas 331 enters the carbon extraction plant and a first portion is reformed by the steam methane reformer reactor 301 and water-gas shift reactor 302 to produce carbon dioxide and hydrogen 332. The carbon dioxide is captured by one of several well-know methods and then compressed to 1,000 psi and stored for further use (for example, for sale, for EOR or for sequestering). Some of the molecular hydrogen 337 exiting the water-gas shift reactor 302 is diverted and mixed with a second portion of the natural gas brought into the carbon extraction plant to produce a mixed gas which is typically about 40% molecular hydrogen and about 60% natural gas by volume. The amount of the natural gas fuel diverted through the plant 214 depends on the application and local carbon emission regulations and the mixed gas may vary in composition from about 20% to about 60% molecular hydrogen, corresponding to about 80% to about 40% natural gas by volume. This mixed gas is used to power a combustion turbine 306 which generates, in this example, about 24 MW of electrical power 361. Using duct burners, for example, this mixed gas is also used to power: the steam methane reformer reactor 301; a heat recovery steam generator (“HRSG”) 304 which produces steam from water 352 input from the output of the tube evaporator (item 210 in FIG. 2) shown in FIG. 2; and a CO₂ absorption apparatus 310. The steam from the HRSG is used in the steam methane reformer reactor 301, water-gas shift reactor 302 and CO₂ absorption apparatus 310. The steam not utilized in the carbon extraction plant is returned to the high pressure steam separator (item 213 in FIG. 2) shown in FIG. 2. An electrical motor is used to drive power turbine 1014 which, in turn, drives a compressor 1015 which compresses the carbon dioxide 1037 to about 1,000 psi. The remainder of the hydrogen produced 336 is sent out of the carbon extraction plant and mixed with the natural gas that by-passed the carbon extraction plant to form a second mixed gas fuel (typically about 60% natural gas and about 40% hydrogen) that is used in the burners of the steam drum generators (item 212 in FIG. 2) shown in FIG. 2.

Natural gas 331, used as the primary fuel to power the operation, is input as shown. Some of the natural gas 331 is mixed with hydrogen (“H₂”) 337 to form a mixed gas fuel 341. The remainder of the natural gas 331 is sent through a heat exchanger 306 to be heated by the output gases from the water-gas shift reactor 302 and then to pick up more heat from the output gases from the steam methane reformer reactor 301 and is then fed into the steam methane reformer reactor 301 to be combined with steam and reformed into syn gas. Syn gas is carbon monoxide (“CO”) and molecular hydrogen (“H₂”) with some carbon dioxide (“CO₂”). The output of the steam methane reformer reactor 301 is sent to the water-gas shift reactor 302 where it is combined with steam to form primarily carbon dioxide (“CO₂”) and molecular hydrogen (“H₂”) 332. In the water-shift reactor 302, typically at least about 80% and more typically at least about 90% of the carbon monoxide is converted into carbon dioxide. These gases are then sent to a CO₂ absorption (or carbon separator) apparatus 310 where any of several well-known processes are used to separate the CO₂ and H₂. The H₂ is sent to a purifier 313 where a portion 337 is then used to mix with natural gas to form a mixed gas fuel (typically about 60% natural gas and about 40% hydrogen by volume). The remainder is sent back to the main plant (FIG. 2) where it can also be used to form a mixed gas fuel.

In the carbon extraction plant of FIG. 3, the mixed gas fuel, mixed in the gas fuel mixer 319, is used to power the steam methane reformer reactor 301; a combustion turbine 306; a heat recovery steam generator (“HRSG”) 304; and a CO₂ absorption apparatus 310. The combustion turbine 306 drives a generator 307 which produces electrical power 361 that is used throughout the carbon extraction plant and the main plant. The heat recovery steam generator 304 is used to produce steam which is delivered to a steam bank for distribution. An electric motor 314 is used to drive a compressor 315 which compresses the CO₂ 338 from the CO₂ absorption apparatus 310 to typically 1,000 psi so that it can be sequestered or sold. The CO₂ absorption apparatus 310 utilizes any of several well-known processes are used to separate the CO₂ and H₂ 332.

Flue gases produced by the various combustion processes may also be used in ways to extract additional energy. The flue gas 342 from the combustion turbine is augmented by mixed gas fuel and used in a duct burner to provide heat for the steam methane reformer reactor 301. The flue gas from the steam methane reformer reactor 301 is augmented by mixed gas fuel and used in a duct burner to provide energy to power the HRSG 304. The de-energized flue gas 349 from the HGRS 304 is vented to the atmosphere.

Water taken from the output of the tube evaporator (item 210 in FIG. 2) shown in FIG. 2, is input to a water storage tank where it is then passed through the water-gas shift reactor to be heated via heat exchanger by the exothermic reaction that occurs in the water-gas shift reactor. This heated water is input to the HRSG to be turned into steam. The steam produced in the HRSG is delivered to a steam bank for distribution to the steam methane reformer reactor; the water-gas shift reactor; and the CO₂ absorption apparatus. A substantial portion of the steam in the steam bank is returned to the high pressure steam separator (item 213 in FIG. 2) in the main plant shown in FIG. 2.

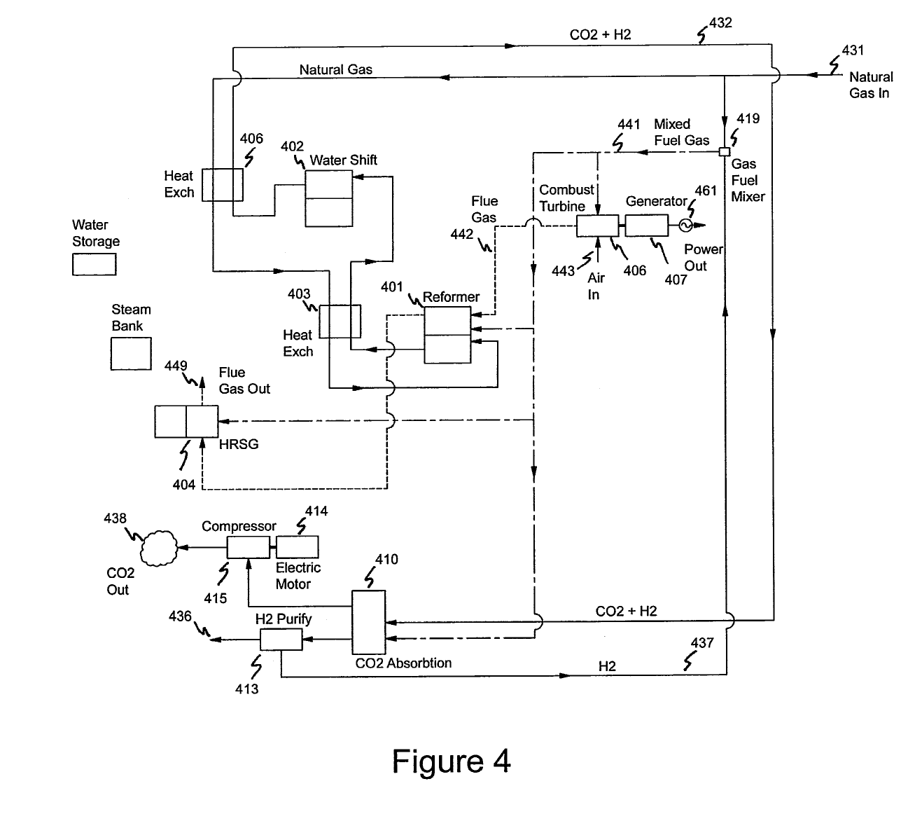

FIG. 4 is a partial schematic of FIG. 3 highlighting fuel and other gas pathways. This is the same as the diagram of FIG. 3 except the water and steam pathways are not shown so that the other pathways can be seen more clearly.

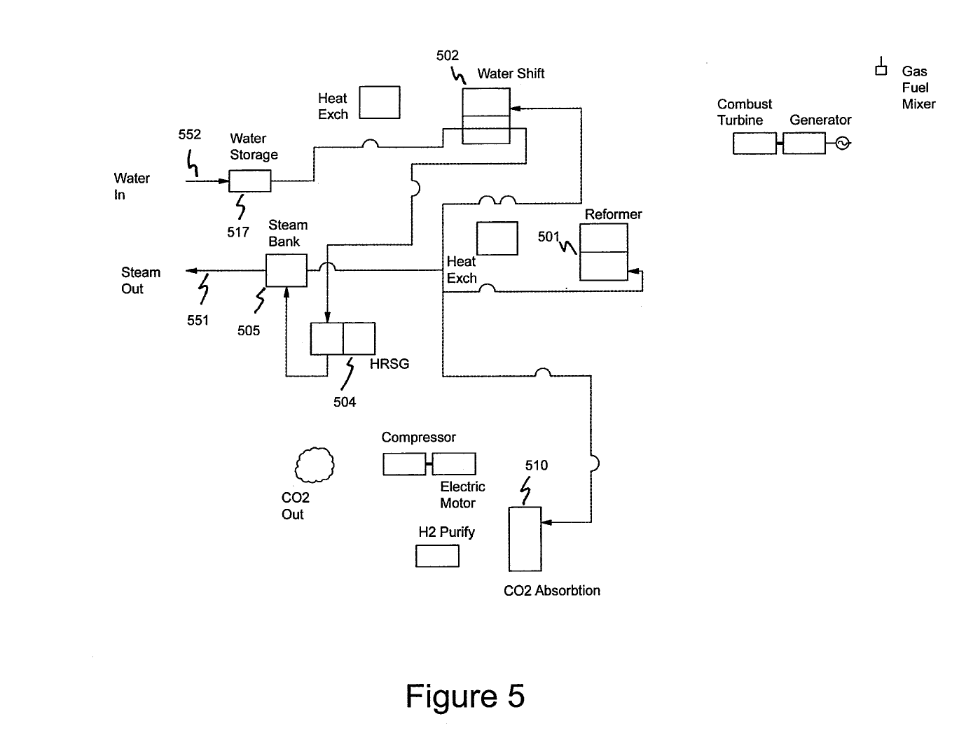

FIG. 5 is a partial schematic of Figure highlighting water and steam pathways. This is the same as the diagram of FIG. 3 except only the water and steam pathways are shown so that they can be seen more clearly.

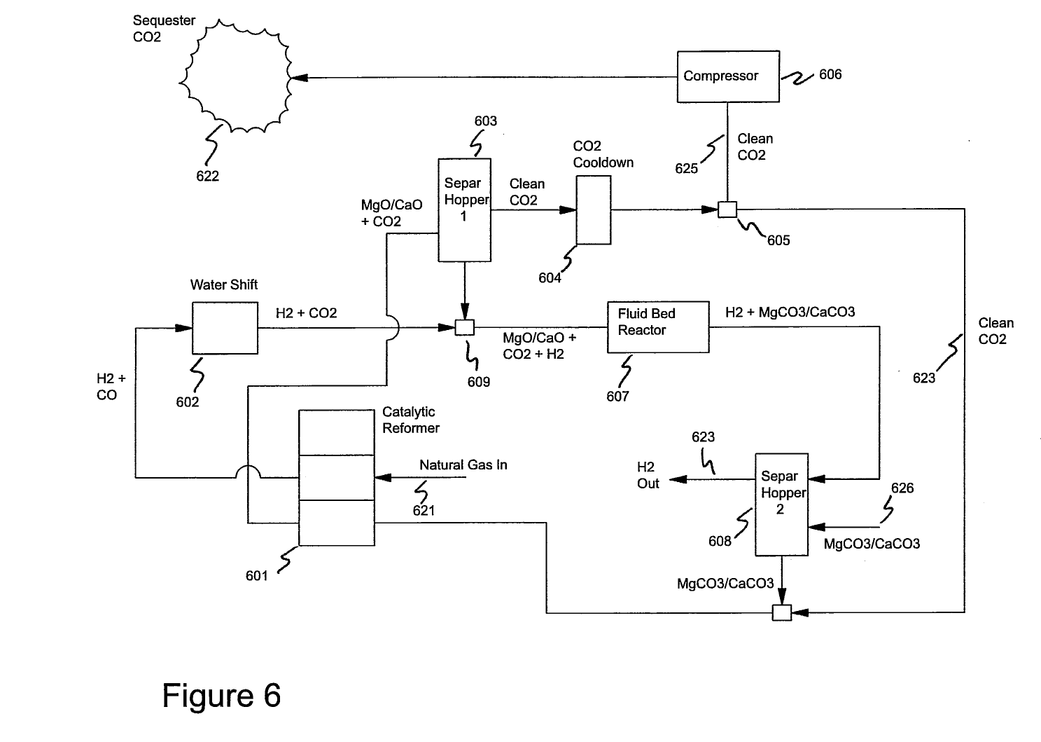

FIG. 6 is a schematic of a pre-combustion CO₂ capture process integrated into a steam methane reforming and water-gas shift process. This is a pre-combustion CO₂ capture method integrated into the steam methane reforming and water-gas shift process in which natural gas is converted to CO₂ and H₂. An alkali and/or an alkaline earth metal oxide, which is preferably a mixture of magnesium oxide and calcium oxide, from a first separation hopper is added to the CO₂ and H₂ and sent through a fluid bed reactor where the mixture is converted to gas stream of H₂ carrying alkali and/or an alkaline earth metal (e.g. magnesium and calcium) carbonates. As will be appreciated, most of the alkali and/or an alkaline earth metal oxides react with carbon dioxide to form alkali and/or an alkaline earth metal carbonates. Preferably at least most and even more preferably at least about 85% of the H₂ is removed in a second separation hopper to form a molecular hydrogen-rich gas that is preferably substantially free and even more preferably contains no more than about 10 mole % carbon dioxide and fossil carbon. The carbonates are added to a clean CO₂ stream (which is preferably substantially free of molecular hydrogen and even more preferably includes no more than about 15 mole % molecular hydrogen) and sent through a heat exchanger in the steam methane reformer where the alkali and/or an alkaline earth metal carbonates are calcined into alkali and/or an alkaline earth metal oxides. These are returned to the first separation hopper, where preferably most, and even more preferably at least about 85% of the CO₂ is removed and sent to a cool down apparatus. A portion of the cooled CO2 is sent to a compressor for subsequent EOR operations or for sale or for sequestering. The remainder of the CO₂ is recycled through the system where it is added to the alkali and/or an alkaline earth metal carbonates to repeat the CO₂ capture cycle.

Utility-grade natural gas 621 is input into a steam methane reformer 601 which produces primarily carbon monoxide (CO) and hydrogen (H₂). This is an endothermic reaction which is operated at temperatures in the approximate range of about 850° C. to 1,100° C. The carbon monoxide and hydrogen gases are sent to a water-gas shift reactor 602 where preferably at least most, and even more preferably at least about 85% of the CO is converted to carbon dioxide (CO₂) by an exothermic reaction forming an output stream of carbon dioxide and hydrogen. In one configuration of the present invention, a mixture of dry magnesium oxide (MgO) and calcium oxide (CaO) is added to this gas stream and is processed through a fluid bed reactor 607 so that most of the carbon dioxide is reacted to form magnesium carbonate (MgCO₃) and calcium carbonate (CaCO₃). The combination of magnesium carbonate and calcium carbonate allows the capture process to occur in minutes. The proportions of magnesium carbonate and calcium carbonate are typically those found in dolomite. The stream of magnesium carbonate, calcium carbonate and hydrogen is transported, with the hydrogen now acting as the carrier fluid, and input into a separation hopper 608 where at least most of the molecular hydrogen 623 is removed and the solid magnesium carbonate and calcium carbonate are stored. Some additional magnesium carbonate and calcium carbonate 626 are added to the recovered magnesium carbonate and calcium carbonate to allow the mixture to be recycled with full potency as described in the paper “SEM Analysis Application to Study CO₂ Capture by Means of Dolomite”, Katia Gallucci, Ferdinando Paolini, Luca Di Felice, Claire Courson, Pier Ugo Foscolo and Alain Kiennemann published in the Open-Access Journal for the Basic Principles of Diffusion Theory, Experiment and Application, 2007. Their experimental studies show that calcined dolomite is a good sorbent of CO₂ with CaO re-carbonating at a temperature of about 800° C. It is also noted that it is possible to calcine dolomite at this same approximate temperature with adequate gas flow. The amount of conversion of CaO from CaCO₃ and MgO from MgCO₃ decreases with the number of calcination/re-carbonation cycles as the dolomite degrades. This process ultimately produces clean CO₂. Some of this is diverted and compressed in compressor 606 in preparation for sequestration or use in EOR operations 622. The remainder is added via path 623 to a stream of magnesium carbonate and calcium carbonate from separation hopper 608 to act as a carrier fluid. This stream is then input into a separate heat exchanger that forms a part of the steam methane reformer 601 where the magnesium carbonate and calcium carbonate are calcined to magnesium oxide and calcium oxide by the heat generated in steam methane reformer 601. Additional carbon dioxide is generated during this process. The stream of carbon dioxide, magnesium carbonate and calcium carbonate is input into a second separation hopper 603 where the CO₂ is separated and sent to a CO₂ cool down apparatus 604 prior to compressing and sequestering. As can be appreciated this carbon dioxide can also be sold as a product or used in EOR operations.

The advantage of this process is that the magnesium oxide and calcium oxide act as a sorbent to bind carbon dioxide to form magnesium carbonate and calcium carbonate. The magnesium carbonate and calcium carbonate are then reduced by heat to form magnesium oxide, calcium oxide and carbon dioxide which can readily be captured. Some of the carbon dioxide is sequestered and some is used to form the gas stream that entrains and carries the magnesium oxide and calcium oxide through the fluid bed reactor and also entrains and carries the magnesium carbonate and calcium carbonate through the heat exchanger in the steam methane reformer. This process is possible because the temperature for steam reforming and for calcination are approximately the same and so can be carried out in a common apparatus.

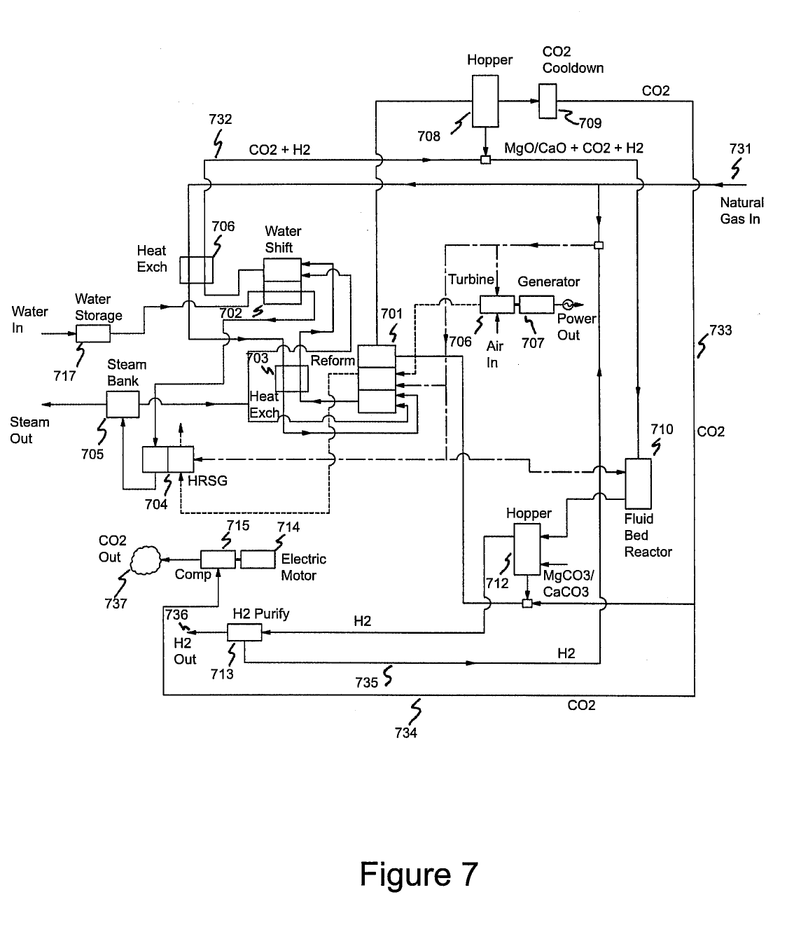

FIG. 7 is schematic of the present invention showing the principal elements of an innovative portion of an integrated SAGD operation (the carbon extraction plant) with the pre-combustion CO₂ capture process of FIG. 6. FIG. 7 is similar to FIG. 3, except the CO₂ absorption facility is replaced by the pre-combustion CO₂ capture process of FIG. 6. As in FIG. 6, the pre-combustion capture system is integrated in with the steam methane reformer reactor.

In FIG. 7, natural gas 731 enters the carbon extraction plant and a first portion is reformed by the steam methane reformer reactor 701 and water-gas shift reactor 702 to produce carbon dioxide and molecular hydrogen 732. The carbon dioxide is captured using the method disclosed in FIG. 6 and then compressed to 1,000 psi and stored for further use (for example, for sale, for EOR or for sequestering). Some of the molecular hydrogen 735 is diverted and mixed with a second portion of the natural gas brought into the carbon extraction plant to produce a mixed gas of about 60% natural gas and about 40% hydrogen. This mixed gas is used to power a combustion turbine 706 which generates electrical power output. Using duct burners, for example, this mixed gas is also used to power: the steam methane reformer reactor 701; the fluid bed reactor 710; and a heat recovery steam generator (“HRSG”) 704 which produces steam from water input which, in turn, comes from the output of the tube evaporator shown in FIG. 2. This steam from the HRSG is used in the steam methane reformer reactor 701 and water-gas shift reactor 702. The steam not utilized in the reforming/water-gas shift process is returned to the high pressure steam separator shown in FIG. 2. An electrical motor is used to drive power turbine 714 which, in turn, drives a compressor 715 which compresses the carbon dioxide 737 to about 1,000 psi. The remainder of the hydrogen produced 736 is sent out of the carbon extraction plant and mixed with the natural gas that by-passed the carbon extraction plant to form a second mixed gas fuel (typically about 60% natural gas and about 40% hydrogen) that is used in the burners of the steam drum generators shown in FIG. 2.

Natural gas 731, used as the primary fuel to power the operation, is input as shown. Some of the natural gas 731 is mixed with molecular hydrogen (“H₂”) to form a mixed gas fuel. The remainder of the natural gas 731 is sent through a heat exchanger 706 to be heated by the output gases from the water-gas shift reactor 702 and then to pick up more heat from the output gases from the steam methane reformer reactor 701 and is then fed into the steam methane reformer reactor 701 to be combined with steam and reformed into syn gas. Syn gas is carbon monoxide (“CO”) and hydrogen molecular (“H₂”) with some carbon dioxide (“CO₂”). The output of the steam methane reformer reactor 701 is sent to the water-gas shift reactor 702 where it is combined with steam to form primarily carbon dioxide (“CO₂”) and molecular hydrogen (“H₂”) 732.

A portion of utility-grade natural gas 731 is input into a steam methane reformer 701 which produces primarily carbon monoxide (CO) and molecular hydrogen (H₂). The carbon monoxide and molecular hydrogen gases are sent to a water-gas shift reactor 702 where most of the CO is converted to CO₂ by an exothermic reaction forming an output stream of carbon dioxide and molecular hydrogen. In the present invention, a mixture of dry magnesium oxide (MgO) and calcium oxide (CaO) is added to this gas stream and is processed through a fluid bed reactor 710 so that most of the carbon dioxide is reacted to form magnesium carbonate (MgCO₃) and calcium carbonate (CaCO₃). The stream of magnesium carbonate, calcium carbonate and molecular hydrogen is transported, with the molecular hydrogen now acting as the carrier fluid, and input into a separation hopper 712 where the molecular hydrogen is removed and the solid magnesium carbonate and calcium carbonate are stored. Some additional magnesium carbonate and calcium carbonate are added to the recovered magnesium carbonate and calcium carbonate to allow the mixture to be recycled with full potency.

This process ultimately produces clean CO₂. Some of this is diverted and compressed in compressor 715 in preparation for sequestration or use in EOR operations 737. The remainder is added via path 723 to a stream of magnesium carbonate and calcium carbonate from separation hopper 708 to act as a carrier fluid. This stream is then input into a separate heat exchanger that forms a part of the steam methane reformer 701 where the magnesium carbonate and calcium carbonate are calcined to magnesium oxide and calcium oxide by the heat generated in steam methane reformer 701. Additional carbon dioxide is generated during this process. The stream of carbon dioxide, magnesium carbonate and calcium carbonate is input into a second separation hopper 708 where the CO₂ is separated and sent to a CO₂ cool down apparatus 709 prior to compressing and sequestering. As can be appreciated this carbon dioxide can also be sold as a product or used in EOR operations.

Flue gases produced by the various combustion processes are also used in ways to extract addition energy. The flue gas from the combustion turbine is augmented by mixed gas fuel and used in a duct burner to provide heat for the steam methane reformer reactor. The flue gas from the steam methane reformer reactor is augmented by mixed gas fuel and used in a duct burner to provide the power to drive the second turbine which operates the compressor. The flue gas from the second turbine is augmented by mixed gas fuel and used in a duct burner to provide energy to power the HRSG. The flue gas from the HGRS is vented to the atmosphere. Although not shown, the flue gases from the heat recovery steam generator may be treated by a post combustion carbon dioxide capture process.

Water taken from the output of the evaporator shown in FIG. 2, is input to a water storage tank where it is then passed through the water-gas shift reactor to be heated via heat exchange by the exothermic reaction that occurs in the water-gas shift reactor. This heated water is input to the HRSG to be turned into steam. The steam produced in the HRSG is delivered to a steam bank for distribution to the steam methane reformer reactor; and the water-gas shift reactor. A substantial portion of the steam in the steam bank is returned to the high pressure steam separator in the main plant shown in FIG. 2.

A number of variations and modifications of the invention can be used. As will be appreciated, it would be possible to provide for some features of the invention without providing others. For example, the carbon extraction plant could be used in conjunction with an electrical power generating plant to form an energy efficient facility run on natural gas where a portion of the natural gas is reformed to eliminate some fossil carbon.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process, comprising:
(a) receiving a gas stream comprising primarily methane;
(b) removing a first portion of the gas stream from a second portion of the gas stream;
(c) converting the first portion of the gas stream to produce a reformed and water-gas shifted gas comprising primarily carbon dioxide and molecular hydrogen;
(d) removing, from the reformed and water-gas shifted gas, at least most of the carbon dioxide to form a product gas; and
(e) thereafter combining the product gas with the second portion of the gas stream to form a mixed gas, whereby a carbon content of the mixed gas is reduced relative to the received gas stream.

2. The method of claim 1, wherein the gas stream is pipeline quality natural gas, wherein the second gas stream is combusted by a turbine to generate electricity, wherein the electricity is used in step (c), and wherein the removed carbon dioxide is utilized to avoid releasing carbon dioxide into the atmosphere.

3. The method of claim 2, wherein the converting step (c) comprises:
(c1) heating the first portion of the gas stream to a temperature ranging from about 250° C. to no more than about 850° C.;
(c2) reforming, by a steam methane reformer, the heated first portion to form a synthetic gas comprising primarily carbon monoxide and molecular hydrogen; and
(c3) converting, by a water-gas shift reaction in a water-gas shift reactor, at least most of the carbon monoxide to carbon dioxide and form a converted first portion comprising primarily carbon dioxide and molecular hydrogen.

4. The method of claim 3, wherein water is heated during step (c3) and further comprising:
(f) converting the heated water into steam; and
(g) using the steam in step (c).

5. The method of claim 3, further comprising:
(f) operating, with a portion of the second gas stream, a combustion gas turbine to produce electrical energy.

6. The method of claim 4, wherein step (d) comprises:
(d1) contacting the reformed and water-gas shifted gas with an alkali and/or an alkaline earth metal oxide to form alkali and/or an alkaline earth metal carbonates and molecular hydrogen;
(d2) thereafter removing, from the reformed and water-gas shifted gas, at least most of the alkali and/or an alkaline earth metal carbonates to form the product gas comprising at least most of the molecular hydrogen; and
(d3) passing the alkali and/or an alkaline earth metal carbonates through a heat exchanger in thermal communication with the steam methane reformer, to reform the alkali and/or an alkaline earth metal oxide and carbon dioxide.

7. The method of claim 6, further comprising:
(f) passing at least a portion of the product gas through a heat exchanger to transfer, to the at least a portion of the product gas, heat from the water-gas shift reaction; and
(g) feeding the heated at least a portion of the product gas to the steam methane reformer to form the synthetic gas.

8. The method of claim 1, wherein the mixed gas comprises no more than about 80% of the carbon present in the received gas stream.

9. A system, comprising:
an input to receive a gas stream comprising primarily methane;
a gas separator to remove a first portion of the gas stream from a second portion of the gas stream;
a steam methane reformer reactor to convert the first portion of the gas stream to a reformed gas comprising primarily molecular hydrogen and carbon monoxide;
a water-gas shift reactor to convert the reformed gas into a reformed and water-gas shifted gas comprising primarily carbon dioxide and molecular hydrogen;
a carbon separator to remove, from the reformed and water-gas shifted gas, at least most of the carbon dioxide to form a product gas; and
a gas combiner to combine the product gas with the second portion of the gas stream to form a mixed gas, whereby a carbon content of the mixed gas is reduced relative to the received gas stream.

10. The system of claim 9, wherein the gas stream is pipeline quality natural gas, wherein the second gas stream is combusted by a turbine to generate electricity, and wherein the removed carbon dioxide is utilized to avoid releasing carbon dioxide into the atmosphere.

11. The system of claim 10, wherein the steam methane reformer reactor heats the first portion of the gas stream to a temperature ranging from about 850° C. to about 1100° C., wherein the water-gas shift reactor comprises at least one of a high temperature water-gas shift reactor and a low temperature water-gas shift reactor, and wherein the reformed gas comprises from about 25 to about 95 mole percent molecular hydrogen and from about 5 to about 25 mole percent carbon monoxide.

12. The system of claim 9, wherein water is heated to a temperature of from about 50° C. to about 300° C. by energy released by the water-gas shift reactor and wherein the heated water is used as the steam in the water-gas shift reactor.

13. The system of claim 9, further comprising:
a combustion gas turbine operated by at least a portion of the mixed gas stream to produce electrical energy.

14. The system of claim 9, wherein the carbon separator performs at least the following operations:
contact the reformed and water-gas shifted with an alkali and/or an alkaline earth metal oxide to form alkali and/or an alkaline earth metal carbonates and molecular hydrogen;
remove, from the reformed and water-gas shifted gas, at least most of the alkali and/or an alkaline earth metal carbonates to form the product gas comprising at least most of the molecular hydrogen and substantially free of carbon dioxide;
pass the alkali and/or an alkaline earth metal carbonates through a heat exchanger in fluid communication with the water-gas shift reactor, to reform the alkali and/or an alkaline earth metal oxide and carbon dioxide, the carbon dioxide being substantially free of molecular hydrogen.

15. The system of claim 9, wherein at least a portion of the product gas is passed through a heat exchanger to transfer, to the at least a portion of the product gas, heat from the water-gas shift reaction, wherein the heated at least a portion of the product gas is fed to the reformer to form the synthetic gas.

16. The system of claim 9, wherein the mixed gas comprises no more than about 80% of the carbon present in the received gas stream.

17. A method, comprising:
(a) forming, from an input gas stream comprising primarily methane, an intermediate gas stream comprising primarily gas-phase molecular hydrogen and carbon oxide;
(b) contacting the intermediate gas stream with an alkali and/or alkaline earth metal oxide to form a second intermediate gas stream comprising molecular hydrogen and carbonates;
(c) removing at least most of the molecular hydrogen from the second intermediate gas stream to form a product gas stream comprising primarily molecular hydrogen and a third intermediate gas stream comprising at least most of the carbonates;
(d) converting, using heat from the forming step (a), at least most of the carbonates in the third intermediate gas stream to gas-phase carbon oxide and alkali and/or alkaline earth metal oxide;
(e) removing at least most of the gas-phase carbon oxide from the alkali and/or alkaline earth metal oxide; and
(f) recycling the separated alkali and/or alkaline earth metal oxide to step (b).

18. The method of claim 17, wherein the gas-phase carbon oxide is primarily carbon dioxide and wherein step (a) comprises:
(A1) heating the the input gas stream to a temperature ranging from about 300° C. to no more than about 850° C.;
(A2) reforming, by a steam methane reformer, the heated input gas stream to form a synthetic gas stream comprising primarily carbon monoxide and molecular hydrogen; and
(A3) converting, by a water-gas shift reaction in a water-gas shift reactor, at least most of the carbon monoxide to carbon dioxide and form the intermediate gas stream, wherein the intermediate gas stream comprises primarily carbon dioxide and molecular hydrogen, wherein the heat in step (d) is from the steam methane reformer.

19. The method of claim 17, wherein the product gas comprises no more than about 25% of the carbon present in the input gas stream.

20. A system to perform the steps of claim 17.
